(19) United States
(12) Patent Application Publication
(10) Pub. No.: US 2019/0305675 A1
(43) Pub. Date: Oct. 3, 2019

(54) ACOUSTIC NOISE REDUCTION IN A DC-DC CONVERTER USING VARIABLE FREQUENCY MODULATION

(71) Applicant: Renesas Electronics America Inc., Milpitas, CA (US)

(72) Inventors: Yen-Mo CHEN, Morrisville, NC (US); Bin LI, Apex, NC (US); Mehul SHAH, Cary, NC (US); Sungkeun LIM, Cary, NC (US)

(21) Appl. No.: 16/382,032

(22) Filed: Apr. 11, 2019

Related U.S. Application Data
(63) Continuation-in-part of application No. 15/979,359, filed on May 14, 2018.
Application No. 15/979,359 is a continuation-in-part of application No. 16/030,800, filed on Jul. 9, 2018.
(60) Provisional application No. 62/656,650, filed on Apr. 12, 2018.
(60) Provisional application No. 62/532,829, filed on Jul. 14, 2017.

(51) Int. Cl. H02M 3/07; H02M 1/08

(52) U.S. Cl. CPC H02M 3/07; H02M 1/08

(57) ABSTRACT

The present embodiments relate generally to switched-capacitor (SC) based DC-DC converters, and more particularly to modulation schemes of cap dividers that include ceramic capacitors such as MLCCs. According to certain general aspects, the present embodiments increase the switching frequency at light loads using variable frequency modulation schemes to reduce the voltage difference across the MLCCs. In these and other embodiments, the acoustic noise generated from the MLCCs can be reduced while maintaining excellent light load efficiency. According to certain aspects, this can be achieved with minimal impact on system performance, cost and size.

### CROSS-REFERENCE TO RELATED APPLICATIONS

The present application is a continuation-in-part of U.S. patent application Ser. No. 15/979,359 filed May 14, 2018, and is also a continuation-in-part of U.S. patent application Ser. No. 16/030,800 filed Jul. 9, 2018, which application claims priority to U.S. Provisional Patent Application No. 62/532,829 filed Jul. 14, 2017. The present application also claims priority to U.S. Provisional Patent Application No. 62/656,650 filed Apr. 12, 2018, the contents of all such applications being incorporated by reference herein in their entirety.

### TECHNICAL FIELD

The present embodiments relate generally to switched-capacitor (SC) based DC-DC converters, and more particularly to modulation schemes of cap dividers that adopt a ladder topology and include ceramic capacitors.

### BACKGROUND

DC-DC converters receive an input voltage from an input source (e.g., mains power, battery, etc.) and use it to provide an output voltage to loads (e.g., computers, IoT appliances, etc.). Conventional DC-DC converters frequently employ topologies that include inductors and power switches such as power MOSFETs. Such inductor-based topologies are problematic and/or they present certain design considerations which are not often easy to resolve.

An alternative to inductor-based topologies are switched-capacitor (SC) based topologies. SC-based DC-DC converters include a flying capacitor that is charged and discharged using switches driven by pulse-width modulation (PWM) or pulse-frequency modulation (PFM) signals so as to transfer energy from an input voltage to an output without the use of inductors. Although SC-based DC-DC converters can thus provide certain benefits over inductor-based topologies, certain opportunities for improvement remain.

### SUMMARY

The present embodiments relate generally to switched-capacitor (SC) based DC-DC converters, and more particularly to modulation schemes of cap dividers that include ceramic capacitors such as MLCCs. According to certain general aspects, the present embodiments increase the switching frequency at light loads using variable frequency modulation schemes to reduce the voltage difference across the MLCCs. In these and other embodiments, the acoustic noise generated from the MLCCs can be reduced while maintaining excellent light load efficiency. According to certain aspects, this can be achieved with minimal impact on system performance, cost and size.

### BRIEF DESCRIPTION OF THE DRAWINGS

These and other aspects and features of the present embodiments will become apparent to those ordinarily skilled in the art upon review of the following description of specific embodiments in conjunction with the accompanying figures, wherein:

FIGS. 1A and 1B are block diagrams illustrating example cap dividers having a ladder topology;

FIGS. 2A and 2B are diagrams illustrating aspects of one example acoustic noise reduction technique;

FIG. 3 is a block diagram illustrating an example modulator for implementing acoustic noise reduction in accordance with the present embodiments;

FIGS. 4A and 4B are diagram illustrating example frequency modulation approaches that can be implemented in connection with the modulator shown in FIG. 3;

FIG. 5 is a block diagram illustrating another example modulator for implementing acoustic noise reduction in accordance with the present embodiments;

FIG. 6 is a block diagram illustrating yet another example modulator for implementing acoustic noise reduction in accordance with the present embodiments;

FIG. 7 is a block diagram illustrating still another example modulator for implementing acoustic noise reduction in accordance with the present embodiments;

FIG. 8 is a block diagram illustrating a further example modulator for implementing acoustic noise reduction in accordance with the present embodiments;

FIGS. 9A and 9B are diagrams illustrating example aspects of benefits achieved by the present embodiments; and

FIG. 10 is a flowchart illustrating an example acoustic noise reduction methodology according to the present embodiments.

### DETAILED DESCRIPTION

The present embodiments will now be described in detail with reference to the drawings, which are provided as illustrative examples of the embodiments so as to enable those skilled in the art to practice the embodiments and alternatives apparent to those skilled in the art. Notably, the figures and examples below are not meant to limit the scope of the present embodiments to a single embodiment, but other embodiments are possible by way of interchange of some or all of the described or illustrated elements. Moreover, where certain elements of the present embodiments can be partially or fully implemented using known components, only those portions of such known components that are necessary for an understanding of the present embodiments will be described, and detailed descriptions of other portions of such known components will be omitted so as not to obscure the present embodiments. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the present disclosure is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

According to certain aspects, the present embodiments are based on an improved switched-capacitor (SC) converter topology that typically does not include an inductor. More particularly, the present embodiments are directed to modulation schemes for SC-based converters that include ceramic capacitors such as MLCCs. According to certain general aspects, the present embodiments increase the switching frequency of the SC-based converter at light loads using variable frequency modulation schemes to reduce the voltage difference across the MLCCs. In these and other embodiments, the acoustic noise generated from the MLCCs can be reduced while maintaining excellent light load efficiency. According to certain aspects, this can be achieved with minimal impact on system performance, cost and size.

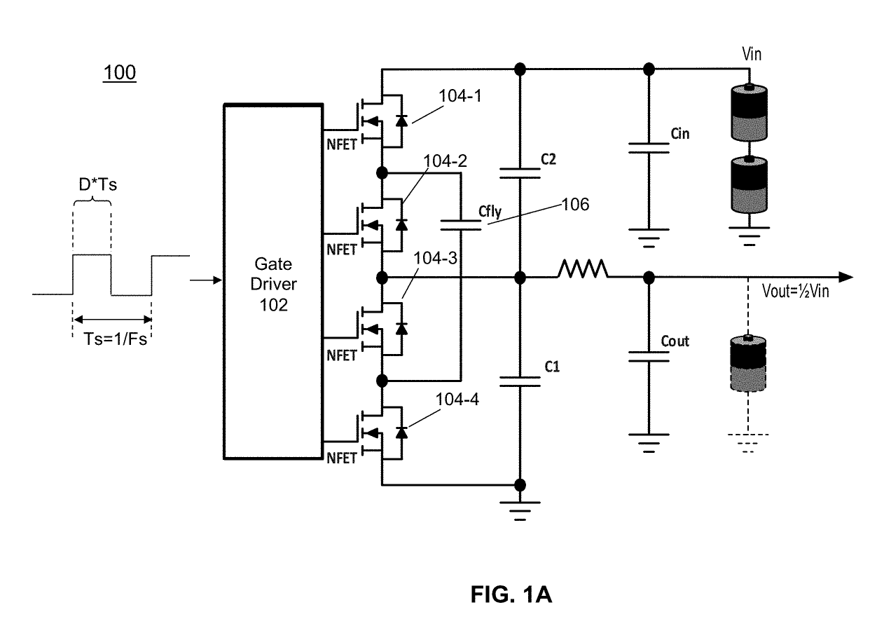

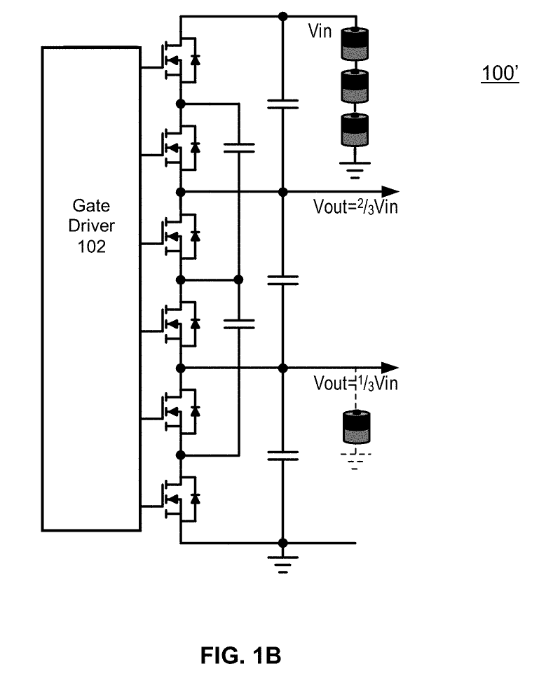

FIG. 1A is a block diagram illustrating an example cap divider topology for a SC converter 100. As shown in this example, an input voltage Vin is provided by a 2S battery. The example Vout is shown as equivalent to a 1S battery (i.e. Vout=Vin/2). A Gate Driver 102 drives four switches (e.g. NFETs) 104 coupled between Vin, Vout and ground so as to charge and discharge a flying capacitor Cfly 106, and thereby transfer the energy from the input to the output. As further shown in FIG. 1A, a gate driving signal is sent to Gate Driver 102 to drive NFETs 104 as will be described in more detail below. The gate driving signal (e.g. from a Modulator, not shown) has a switching frequency Fs, a switching period Ts, and a duty cycle D, which in this case will ideally be about 50% due to the ratio of the input and output voltages Vin and Vout in this illustrated embodiment. However, other duty cycle ratios are possible for this embodiment and other embodiments to achieve certain performance metrics such as efficiency, ripple, or various types of noise. Moreover, although Vin is shown in this example as being provided by a battery, other types of power sources are possible, such as power from an adapter, a power bank or other supplies that provide an adequate DC voltage. Vout can be provided to any type of load such as a CPU voltage regulator, an electronic load, a battery, a portable device, an IoT appliance, etc.

As will be appreciated by those skilled in the art, the switched capacitor converter 100 shown in FIG. 1A adopts a ladder topology, which topology can be easily extended to other embodiments in which other Vout-Vin ratios are desired. For example, the circuit in FIG. 1A can be adapted for use for providing a Vout=Vin/3 ratio and/or a Vout=2Vin/3 ratio with the addition of two or more switched capacitors (i.e. flying capacitors and associated switches) as shown in FIG. 1B. However, further details thereof will be omitted here for sake of clarity of the invention. It should also be noted that the present embodiments are not limited to a ladder topology, and other topologies are possible, such as a serial-parallel topology, a doubler topology, etc., and those skilled in the art will be able to understand how to implement the present embodiments in such other topologies after being taught by the present examples.

Among other things, the present applicant recognizes that with topologies such as those shown in FIGS. 1A and 1B, multi-layer ceramic capacitors (MLCCs) are widely used. More particularly in connection with the example of FIG. 1A, MLCCs are used to implement any or all of Cfly 106 and the output and decoupling capacitors C1 and C2. Large capacitance with low profile. MLCCs are popular because they have good parasitic properties such as very low effective series resistance and inductance, they present low impedance at higher frequencies, they have a high reliability over time, and they are very low-cost. As such, they are very desirable to use and using other types of capacitors would have many disadvantages.

However, the applicant further recognizes that when an AC voltage (such as the alternating gate driving voltage shown in FIG. 1A) is applied to a MLCC, the dielectric will undergo expansion and contraction due to the electric fields. If the voltage fluctuation causes a deformation at a frequency range from 20 Hz to 20 kHz, it could be audible to humans and therefore create acoustic noise. Various methods have been attempted to reduce the acoustic noise such as adding metal terminals or an interposer substrate to suppress the transmission of vibrations, using a thicker PCB that can allow the sound frequency to shift due to weight change, placing the components at the edge of the PCB to reduce the sound pressure level, placing capacitors, preferably with smaller size, on each side of the PCB to cancel the vibration, and reducing voltage amplitude variation across the capacitors. However, these attempts can increase cost, complexity or have other undesirable effects.

According to certain aspects, therefore, although the duty cycle D can remain substantially constant based on the required input-to-output voltage conversion ratio n (e.g., n=½), the present embodiments are directed to providing a variable frequency modulation scheme for the switching frequency Fs so as to reduce or eliminate acoustic noise that results from the expansion and contraction of the MLCC dielectric.

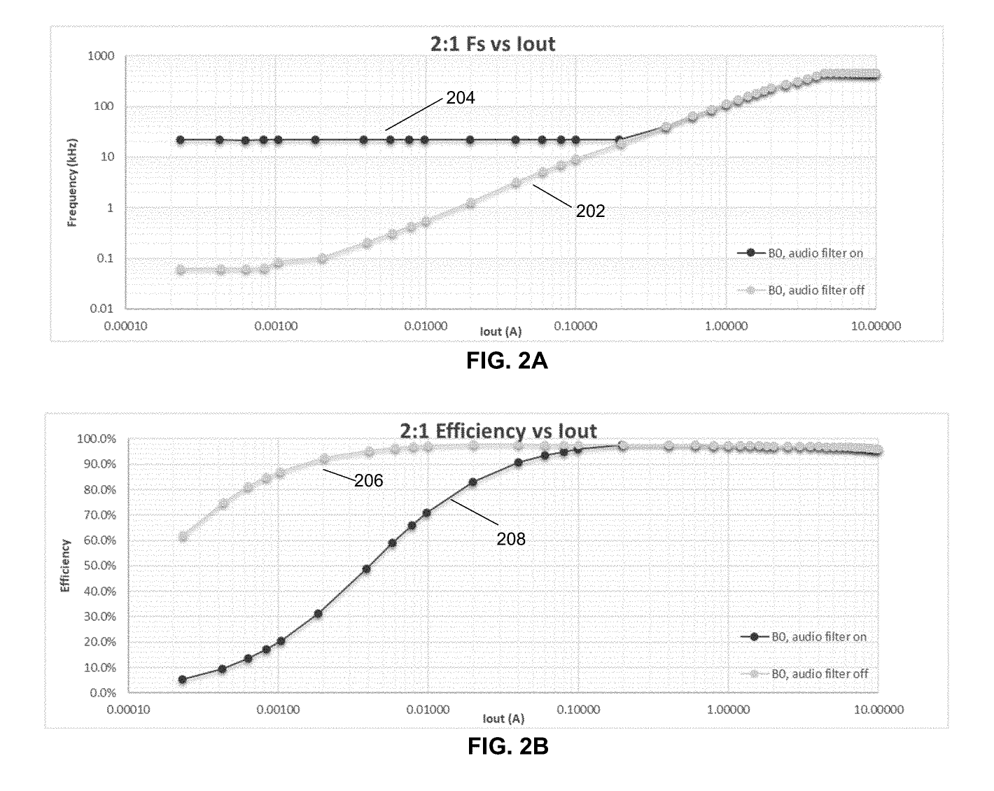

One possible approach is to simply apply an audio filter that forces the modulator to partially/completely avoid a switching frequency Fs in the audible frequency range. For example, FIG. 2A is a graph that illustrates this approach in a 2:1 cap divider circuit such as that shown in FIG. 1A. In FIG. 2A, curve 202 represents a conventional operation of SC converter 100, wherein a modulator adjusts the switching frequency Fs based on load conditions. As can be seen, based on load conditions requiring an Iout of between about 0.001 A and 5 A, the switching frequency Fs is varied in a substantially uniform fashion from about 100 Hz to about 500 kHz, which includes the audible range from 20 Hz up to about 20 kHz (as shown by curve 202, a switching frequency of 20 kHz corresponds to a load of about 0.2 A in this example). Accordingly, during the conventional operation of converter 100 there will be audible noise from the MLCCs at light loads below about 0.2 A.

Meanwhile, curve 204 in FIG. 2A represents an operation of SC converter 100 where the modulator includes an audio filter. As shown, during operation of converter 100 at heavier loads above about 0.2 A, curve 204 is the same as curve 202. However, at lighter loads, curve 204 differs from curve 202 by keeping a constant switching frequency Fs of about 20 kHz. This forces the converter 100 to operate with a switching frequency above the audible range, even when lighter load conditions would otherwise allow for a lower switching frequency to be used.

Although this approach successfully eliminates acoustic noise during operation of converter 100 due to the expansion and contraction of the dielectric in the MLCCs, it has certain disadvantages. One drawback of this approach is illustrated by the diagram of FIG. 2B. In this diagram, curve 206 represents the conventional operation of converter 100, and curve 208 represents the operation of converter 100 with an audio filter as described in connection with FIG. 2A. As can be seen from curve 208 as compared to curve 206, coincident with the audio filter engaging at light loads below about 0.2 A, the efficiency of operation of converter 100 with an audio filter is much lower than the efficiency of converter 100 operating in the conventional manner.

According to certain additional aspects, therefore, the present embodiments provide acoustic noise reduction techniques that do not result in substantial drawbacks such as the approach described above in connection with FIGS. 2A and 2B.

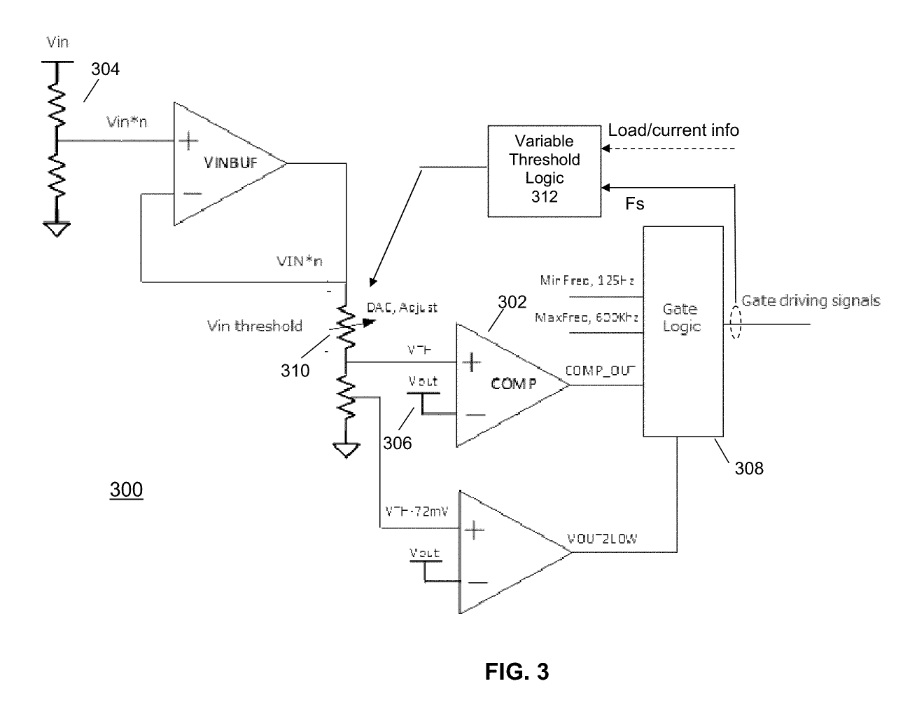

One approach according to the present embodiments can be implemented by an example modulator 300 shown in FIG. 3. This modulator 300 can be used to generate gate driving signals for a converter such as converter 100 shown in FIG. 1 that are provided to gate driver 102 and used to drive the switching transistors 104. Generally, in this example, gate driving signal generation is adjusted on the basis of the output of a comparator 302. This approach requires two sensing circuits 304, 306, one for Vin and one for Vout, as well as a comparator 302. Variable frequency modulation is performed by logic 308 on the basis of the results of comparing Vout to Vin*n−Vin threshold (where n=½, for the example converter 100 shown in FIG. 1A).

In general operation, modulator 300 will cause converter 100 to output gate driving signals that have a substantially constant duty cycle (e.g. D=½ in the example converter 100), but with a variable switching frequency Fs based on load conditions, and the switching frequency Fs can therefore generally follow the operation of curve 202 shown in FIG. 2A. However, as further shown in FIG. 3, modulator 300 further includes variable threshold logic 312. Logic 312 monitors the switching frequency Fs and will adjust the Vin threshold in a manner to reduce acoustic noise caused by the resulting expansion and contraction of the dielectric in the MLCCs. As shown in the example of FIG. 3, this is accomplished by logic 312 causing the resistance provided by resistor 310 to change, which thereby causes the Vin threshold to change. This change in Vin threshold will further cause the switching frequency Fs of the gate driving signals output by gate logic 308 to change. In one example implementation, resistor 310 is implemented by a variable resistor or adjustable DAC. In other example implementations, resistor 310 is implemented by multiple value resistances connected in parallel, with switches to selectively connect one of the resistances at a time.

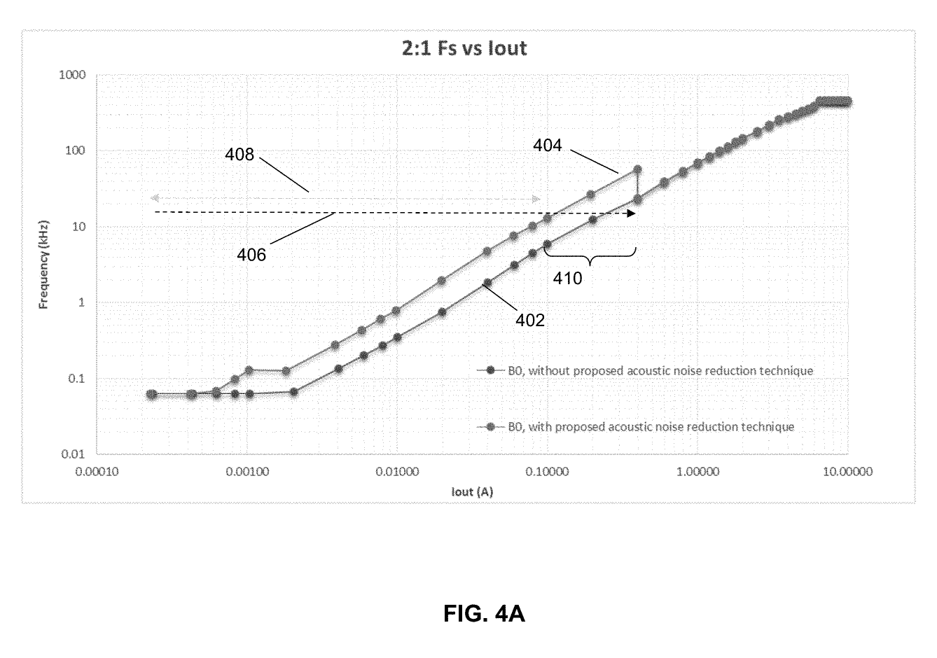

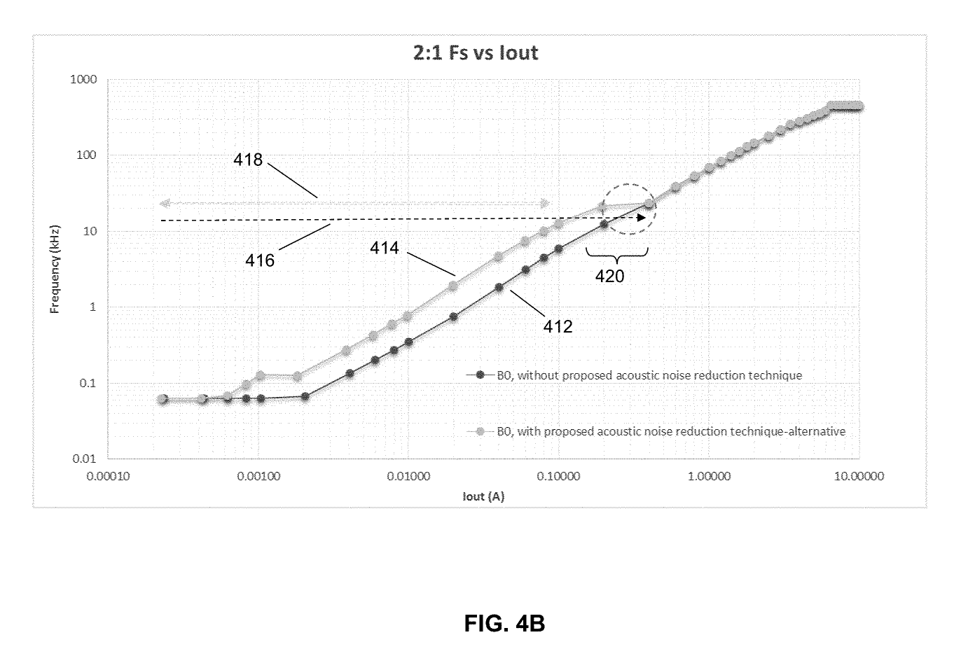

One example of how this can be implemented in a 2:1 cap divider converter such as converter 100 in FIG. 1A is illustrated in the diagram of FIG. 4A. In FIG. 4A, curve 402 represents an operation of modulator 300 without logic 312, and curve 404 represents an operation of modulator 300 with logic 312. As can be seen by comparison of curves 402 and 404, the operation of modulator 300 at higher loads (e.g. above around 0.5 A) is the same with or without logic 312. However, with logic 312, the switching frequency is monitored, and when it falls below about 30 kHz, logic 312 causes the Vin threshold to be decreased (e.g. by changing the value of the resistance 310). This causes the switching frequency to be increased in lighter loads in comparison to the higher Vin threshold when operating without logic 312. The acoustic noise in lighter loads is therefore reduced. In one non-limiting example of FIG. 4A (e.g. in connection with a 2S:1S SC converter), the Vin threshold is lowered from 60 mV at higher loads to 30 mV at lower loads. Logic 312 can do this by selectively connecting one of two different resistances into the path of resistor 310 in FIG. 3 when the switching frequency rises above 60 kHz or falls below 30 kHz. It should be noted that logic 312 can apply some hysteresis to this threshold frequency so as to prevent jumping back and forth between resistances in frequencies close to 60 kHz or 30 kHz. As can be further seen the change in Vin threshold causes the range 406 of operating loads where acoustic noise is present without logic 312 to be reduced to the range 408 with logic 312. Put another way, the operation of logic 312 results in an increased range of loads 410 where acoustic noise is eliminated.

Another example of how this can be implemented in a 2:1 cap divider converter such as converter 100 in FIG. 1A is illustrated in the diagram of FIG. 4B. In FIG. 4B, curve 412 represents an operation of modulator 300 without logic 312, and curve 414 represents an operation of modulator 300 with logic 312. As can be seen by comparison of curves 412 and 414, the operation of modulator 300 at higher loads (e.g. above around 0.5 A) is the same with or without logic 312. However, with logic 312, the switching frequency is monitored, and when it falls below about 20 kHz, logic 312 causes the Vin threshold to be decreased (e.g. by changing the value of the resistance 310). This causes the switching frequency to be increased in lighter loads in comparison to the higher Vin threshold when operating without logic 312. In one non-limiting example of FIG. 4B (e.g. in connection with a 2S:1S SC converter), the Vin threshold is gradually lowered from 60 mV at higher loads to 30 mV at lower loads. Logic 312 can do this by variably adjusting the value of the resistance in the path of resistor 310 in FIG. 3 when the switching frequency rises above or falls below 20 kHz and when the Vin threshold is at either extreme of 30 mV or 60 mV, respectively. It should be noted that load current information can also or alternatively be sensed to implement the hysteresis and plateau (e.g. around 0.2 A and 0.4 A in this example). As can be further seen, the change in Vin threshold causes the range 416 of operating loads where acoustic noise is present without logic 312 to be reduced to the range 418 with logic 312. Put another way, the operation of logic 312 results in an increased range of loads 420 where acoustic noise is eliminated.

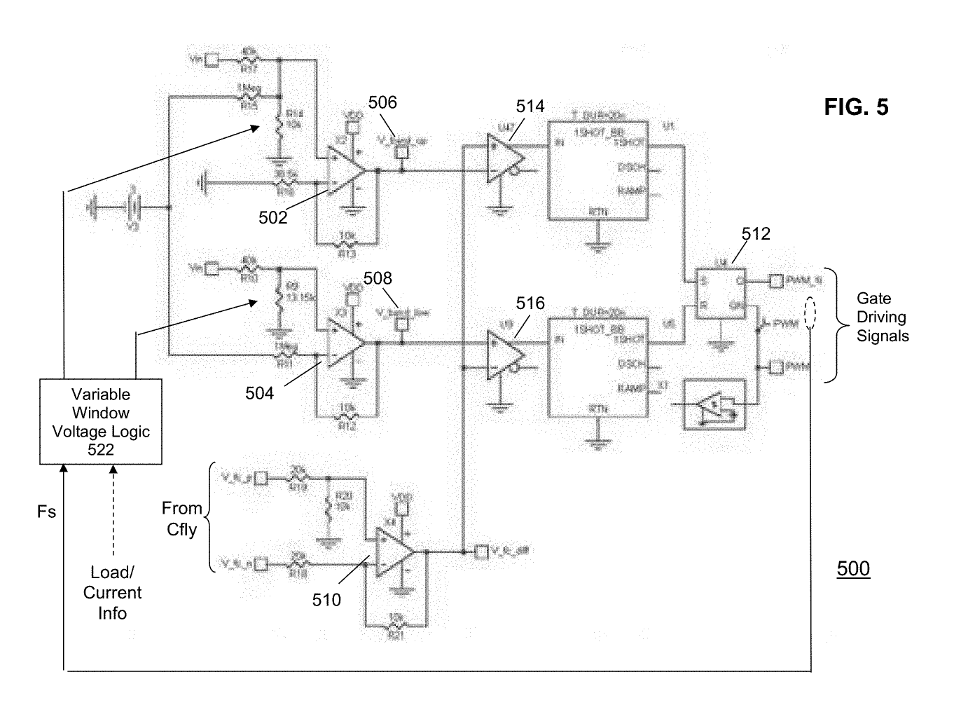

An alternative to modulator 300, but which can obtain similar results as shown in FIGS. 4A and 4B, is a hysteresis-window modulator 500, an example of which is shown in FIG. 5. In this approach, as shown in FIG. 5, gate driving signal generation is adjusted using comparator outputs based on a hysteresis window of the flying cap Cfly voltage. Two operational amplifiers 502, 504 are used to provide the upper and lower window levels 506, 508, respectively based on an input voltage. The voltage differential on the flying cap voltage is measured by amplifier 510. Variable frequency modulation is performed by gate logic 512 on the basis of comparing the flying cap voltage to the hysteresis windows using comparators 514, 516.

As further shown in FIG. 5, modulator 500 according to embodiments further includes variable window voltage logic 522. Without logic 522, modulator 500 can provide variable switching frequency modulation such as that shown by curve 202 in FIG. 2A. However, similar to logic 312 in modulator 300, logic 522 monitors the switching frequency of the gate driving signals and uses the monitored frequency to adjust the upper and lower window voltages (e.g. by adjusting the resistor networks around amplifiers 502, 504) to obtain the results shown in FIG. 4A. Modulator 500 can also or alternatively monitor the load current to implement the hysteresis and plateau shown in FIG. 4B. In this example (e.g. in connection with a 2S:1S SC converter), based on the monitored switching frequency Fs, a smaller hysteresis window (e.g. 60 mV) is used at light loads, and a larger hysteresis window (e.g. 120 mV) is used at higher loads.

The example embodiments above modulate the switching frequency by directly monitoring when the switching frequency is approaching the acoustic range, and adjusting a Vin threshold or hysteresis voltage window in response. However, other approaches are possible in accordance with additional embodiments.

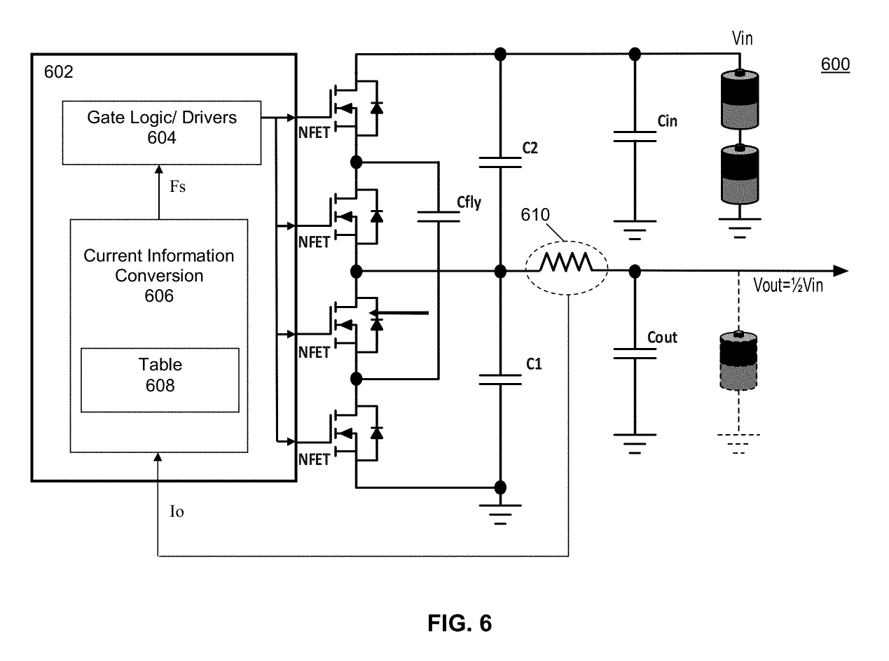

As shown in the example embodiment of FIG. 6, a modulator 602 for a SC-based converter 600 includes gate logic/drivers 604 and current information conversion logic 606. As further shown, current information conversion logic 606 uses a lookup table 608 to convert a current sensed from sense resistor 610 into a switching frequency, a duty cycle, and any pulse-generation or pulse-skipping parameters that can be implemented by gate logic/drivers 604. For example, lookup table 608 stores data corresponding to predefined current-to-frequency curves from which current information conversion logic 606 can select and/or determine an appropriate switching frequency based on the sensed current information. Note that the sense resistor 610 can be placed on the input side as well as other appropriate locations or be substituted with other current-sensing techniques.

The current information can be mapped to various switching frequency options through lookup table 608 depending on efficiency/ripple targets, for example. For example, table 508 can store data corresponding to either or both of curves 404 and 414 in FIGS. 4A and 4B. Logic 606 can be configured to select among the curves in table 608 (e.g., select between curve 404 or 414), for example using pinstraps, input signals or other such mechanisms and algorithms (not shown) at any given time or under certain operating conditions.

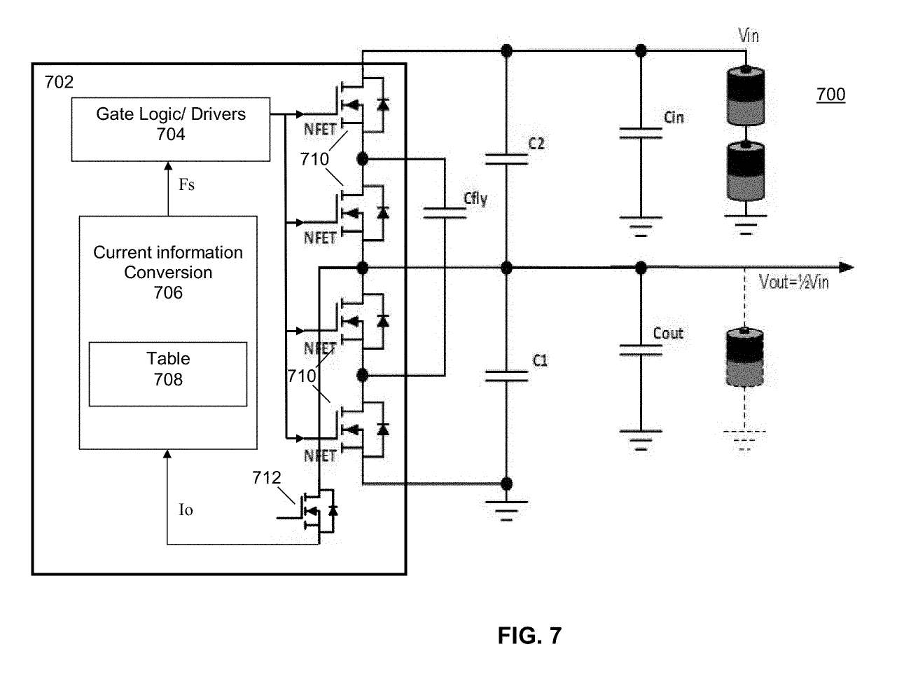

FIG. 7 is a block diagram of another example frequency modulation scheme according to the present embodiments.

As shown in this example, a modulator 702 for SC-based converter 700 includes gate logic/drivers 704 and current information conversion logic 706, as well as integrated power MOSFETs 710 and an integrated SENSEFET 712. As further shown, current information conversion logic 706 uses a lookup table 708 to convert a current sensed from SENSEFET 712 into a switching frequency, a duty cycle and any pulse-generation or pulse-skipping parameters that can be implemented by gate logic/drivers 704. Similar to the previous example, lookup table 708 stores data corresponding to predefined current-to-frequency curves (e.g. data corresponding to curves 404 and 414 in FIGS. 4A and 4B) from which current information conversion logic 706 can select and/or determine an appropriate switching frequency based on the sensed current information, as will be described in more detail below.

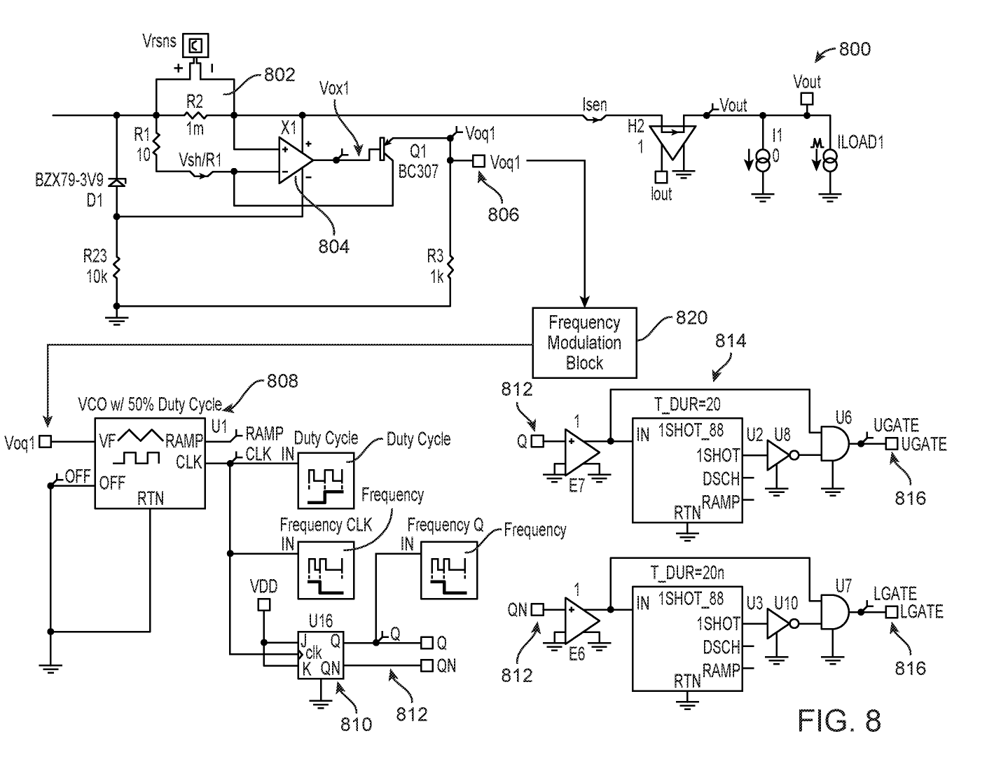

FIG. 8 is a block diagram of yet another example frequency modulation scheme according to the present embodiments.

Differently from the other example, this scheme does not include lookup tables. Rather, in modulator 800, the current is used directly to generate a switching frequency. Current sensing is performed using a current sense resistor 802 and a low voltage current sense amplifier 804 (e.g. operational amplifier) with level shifting to produce a sense voltage 806. This sense voltage 806 is fed to frequency modulation block 820 which produces an output voltage to a voltage controlled oscillator (VCO) 808. Frequency modulation block 820 includes logic to determine whether the load conditions allow for adjusting the switching frequency as described above in connection with FIGS. 4A and 4B, and produces an output voltage to achieve the reduced acoustic noise switching frequency.

The VCO 808 produces a fixed duty cycle clock signal output (e.g. 50% duty cycle for example) having a frequency dependent on the voltage output from block 820. This clock signal is provided as a clock input to J-K flip flop 810 to produce a gate driving signal Q and a complementary gate driving signal QN at its Q and QN outputs, respectively. These signals 812 are provided to driver 814 to thereby drive (e.g. using one-shots) the gates of the appropriate switches at a switching frequency determined by block 820.

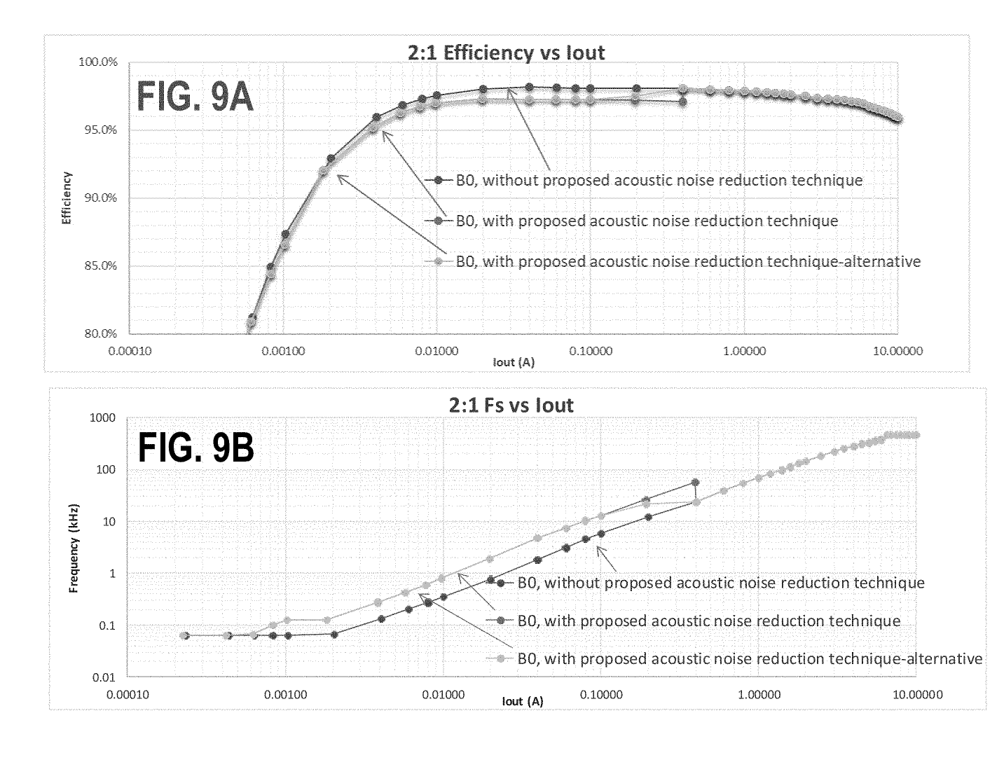

FIGS. 9A and 9B are diagrams illustrating example operational aspects of the present embodiments. More particularly, FIG. 9A juxtaposes the various switching frequency versus Iout curves 402, 404 and 414 shown in FIGS. 4A and 4B and FIG. 9B provides corresponding efficiency curves for each of these examples. As can be seen in FIG. 9A, the efficiencies with the acoustic noise reduction schemes according to the present embodiments at light loads are slightly lower than without such schemes. However, the reduction is only about 1-2% at most, which is a favorable tradeoff for the reduction in acoustic noise that is achieved. Moreover, the reduction in efficiency is much less than in conventional noise reduction techniques such as those described in connection with FIGS. 2A and 2B.

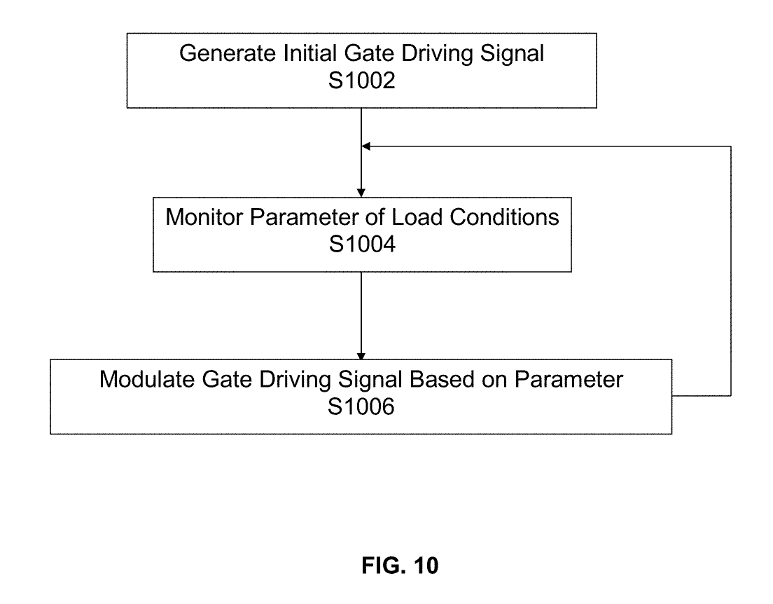

FIG. 10 is a flowchart of an example gate signal modulation methodology according to embodiments.

As shown in this example, in a step S1002, an initial gate driving signal is generated with appropriate switching frequency, duty cycle, and any other pulse generation or pulse skipping parameters. The switching frequency of the gate driving signal, for example, can be a predetermined frequency but may be adjusted if necessary. As set forth above, the duty cycle can be fixed in accordance with a required input-to-output voltage conversion ratio but other duty cycles are also possible. For example, if the ratio is Vout=Vin/2, then the duty cycle can be set at 50%, 45%, 40%, etc.

In step S1004 a parameter of a load condition is sensed. For example, the parameter can be the switching frequency of the gate driving signal as described above in connection with FIGS. 3 and 5. In other embodiments such as those described in connection with FIGS. 6-8, the parameter can be the current being drawn by the load. This can be sensed in various ways as set forth above, such as using a sense resistor at or near an output node or input node, a SENSEFET near power transistors, etc.

In response to the sensed parameter (e.g. current), in step S1006 the gate signal is modulated to reduce acoustic noise caused by the MLCCs if necessary. In some example embodiments, a Vin threshold or hysteresis window voltage is adjusted. In other embodiments, a lookup table is used to determine the appropriate switching frequency for the given current (i.e. load condition). In other embodiments not including a lookup table, a direct current-to-frequency conversion operation can be performed, for example using a VCO.

The steps above can be repeated continuously until no further modulation is needed.

Although the present embodiments have been particularly described with reference to preferred ones thereof, it should be readily apparent to those of ordinary skill in the art that changes and modifications in the form and details may be made without departing from the spirit and scope of the present disclosure. It is intended that the appended claims encompass such changes and modifications.

What is claimed is:

1. An apparatus for converting an input voltage at an input to an output voltage at an output, the apparatus comprising:
a capacitor, wherein the capacitor is configured such that a charging and discharging of the capacitor transfers energy from the input to the output;
switches configured to control the charging and discharging of the capacitor; and
a controller that controls a switching frequency of the switches based on a desired level of acoustic noise reduction and in accordance with a sensed parameter.

2. The apparatus of claim 1, wherein the acoustic noise is due to expansion and contraction of the capacitor in accordance with the switching frequency.

3. The apparatus of claim 1, wherein the capacitor is a multi-layer ceramic capacitor.

4. The apparatus of claim 1, wherein the sensed parameter is a current at the output, the apparatus further comprising a lookup table coupled to the controller, wherein the controller is configured to set the switching frequency based on the current using one or more entries in the lookup table.

5. The apparatus of claim 1, wherein the controller includes a voltage threshold modulator that uses a voltage threshold to adjust the switching frequency, the voltage threshold being adjusted in accordance with the sensed parameter.

6. The apparatus of claim 1, wherein the controller includes a hysteresis modulator that uses a window voltage to adjust the switching frequency, the window voltage being adjusted in accordance with the sensed parameter.

7. The apparatus of claim 1, wherein the switches comprise FETs, and wherein the controller is coupled to provide gate driving signals to the gates of the FETs, the gate driving signals having the switching frequency.

8. The apparatus of claim 7, wherein the sensed parameter is a frequency of the gate driving signals.

9. The apparatus of claim 1, further comprising a decoupling capacitor for use in charging the capacitor with the input voltage, wherein the decoupling capacitor comprises a multi-layer ceramic capacitor.

10. The apparatus of claim 1, further comprising an output capacitor for use in storing the output voltage as a result of the discharging of the capacitor, wherein the decoupling capacitor comprises a multi-layer ceramic capacitor.

11. A method for converting an input voltage at an input to an output voltage at an output, the method comprising:
charging and discharging a capacitor so as to transfer energy from the input to the output;
operating switches to control the charging and discharging of the capacitor; and
controlling, by a controller, a switching frequency of the switches based on a desired level of acoustic noise reduction and in accordance with a sensed parameter.

12. The method of claim 11, wherein the sensed parameter is a current at the output, the method further comprising setting, by the controller, the switching frequency based on the current using one or more entries in a lookup table.

13. The method of claim 11, wherein controlling includes using a voltage threshold to adjust the switching frequency, the voltage threshold being adjusted in accordance with the sensed parameter.

14. The method of claim 11, wherein controlling includes using a hysteresis window voltage to adjust the switching frequency, the hysteresis window voltage being adjusted in accordance with the sensed parameter.

15. The method of claim 11, wherein the switches comprise FETs, the method further comprising providing, by the controller, gate driving signals to the gates of the FETs, and wherein the sensed parameter is a frequency of the gate driving signals.
